(19) United States
(12) Patent Application Publication
(10) Pub. No.: US 2009/0006942 A1
(43) Pub. Date: Jan. 1, 2009

(54) EMBEDDED MARKUP RESOURCES

(75) Inventor: Wei Zhu, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/770,710

(22) Filed: Jun. 28, 2007

(51) Int. Cl. G06F 17/00

(52) U.S. Cl. 715/234

(57) ABSTRACT

A client communicating with a world wide web server retrieves a markup language document including a markup insertion method and a design template including a markup language resource. The markup language resource includes an identifier and a portion of markup language code. The client renders the markup language document and executes the markup insertion method to insert copies of the markup language code associated with markup language resources.

### BACKGROUND

In world wide web client applications, the markup language for each document is typically sent down the client with each new request. Each document may share similar markup for common user interface elements. For example, the markup for a button or a table may be similar among a collection of similar markup language pages.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and methods for embedded markup language resources in design templates, source code files, and the like. The markup language resources include portions of markup language code that may be copied or cloned into markup language object model fragments before being inserted into the markup language document object model. A client rendering the markup language document may call a lookup function to return the markup language fragment.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example of a computing device for implementing one or more embodiments of the invention.

FIG. 2 shows an example embedded markup resource system.

FIG. 3 shows an example design template including a markup language resource.

FIG. 4 shows an example implementation of a markup language resource

FIG. 5 shows an example markup insertion method.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an embedded markup language resource system, the system described is provided as an example and not a limitation. As those skilled in the art will appreciate, the present examples are suitable for application in a variety of different types of embedded markup language resource systems.

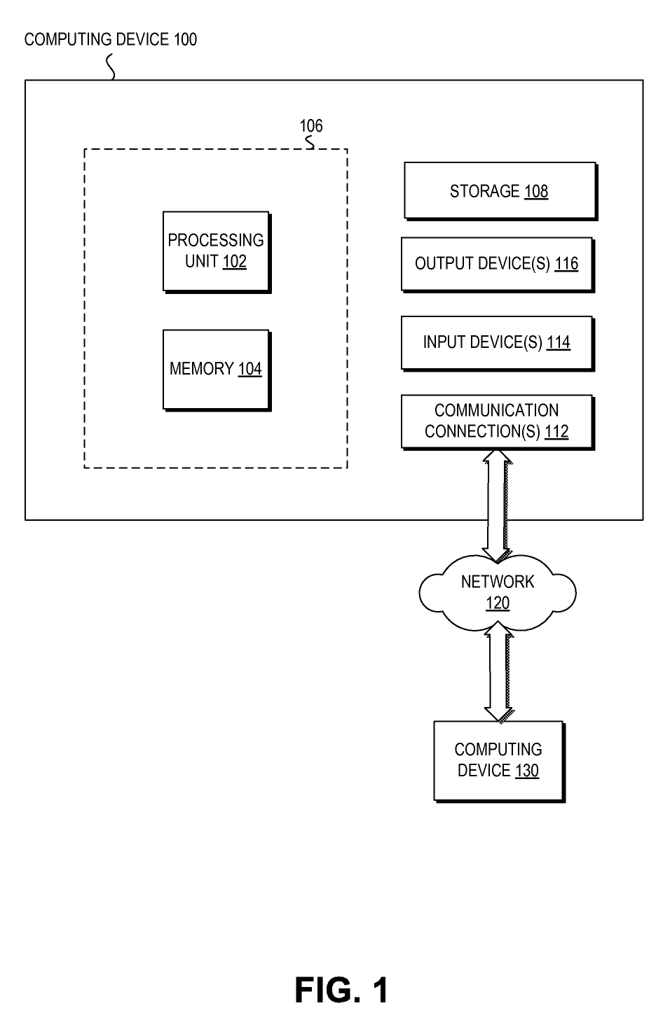

FIG. 1 and the following discussion are intended to provide a brief, general description of a suitable computing environment to implement embodiments of the invention. The operating environment of FIG. 1 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention will be described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 1 shows an example of a computing device 100 for implementing one or more embodiments of the invention. In one configuration, computing device 100 includes at least one processing unit 102 and memory 104. Depending on the exact configuration and type of computing device, memory 104 may be volatile (such as RAM), non-volatile (such as ROM, flash memory, etc.) or some combination of the two. This configuration is illustrated in FIG. 1 by dashed line 106.

In other embodiments, device 100 may include additional features and/or functionality. For example, device 100 may also include additional storage (e.g., removable and/or non-removable) including, but not limited to, magnetic storage, optical storage, and the like. Such additional storage is illustrated in FIG. 1 by storage 108. In one embodiment, computer readable instructions to implement embodiments of the invention may be stored in storage 108. Storage 108 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 104 and storage 108 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also include communication connection(s) 112 that allow device 100 to communicate with other devices. Communication connection(s) 112 may include, but is not limited to, a modem, a Network Interface Card (NIC), or other interfaces for connecting computing device 100 to other computing devices. Communication connection(s) 112 may include a wired connection or a wireless connection. Communication connection(s) 112 may transmit and/or receive communication media.

Communication media typically embodies computer readable instructions or other data in a “modulated data signal” such as a carrier wave or other transport mechanism and includes any information delivery media. The term “computer readable media” may include communication media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media.

Device 100 may include input device(s) 114 such as keyboard, mouse, pen, voice input device, touch input device, infra-red cameras, video input devices, and/or any other input device. Output device(s) 11 6 such as one or more displays, speakers, printers, and/or any other output device may also be included in device 100. Input device(s) 114 and output device(s) 116 may be connected to device 100 via a wired connection, wireless connection, or any combination thereof. In one embodiment, an input device or an output device from another computing device may be used as input device(s) 114 or output device(s) 116 for computing device 100.

Components of computing device 100 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 100 may be interconnected by a network. For example, memory 104 may be comprised of multiple physical memory units located in different physical locations interconnected by a network.

Those skilled in the art will realize that storage devices utilized to store computer readable instructions may be distributed across a network. For example, a computing device 130 accessible via network 120 may store computer readable instructions to implement one or more embodiments of the invention. Computing device 100 may access computing device 130 and download a part or all of the computer readable instructions for execution. Alternatively, computing device 100 may download pieces of the computer readable instructions, as needed, or some instructions may be executed at computing device 100 and some at computing device 130. Those skilled in the art will also realize that all or a portion of the computer readable instructions may be carried out by a dedicated circuit, such as a Digital Signal Processor (DSP), programmable logic array, and the like.

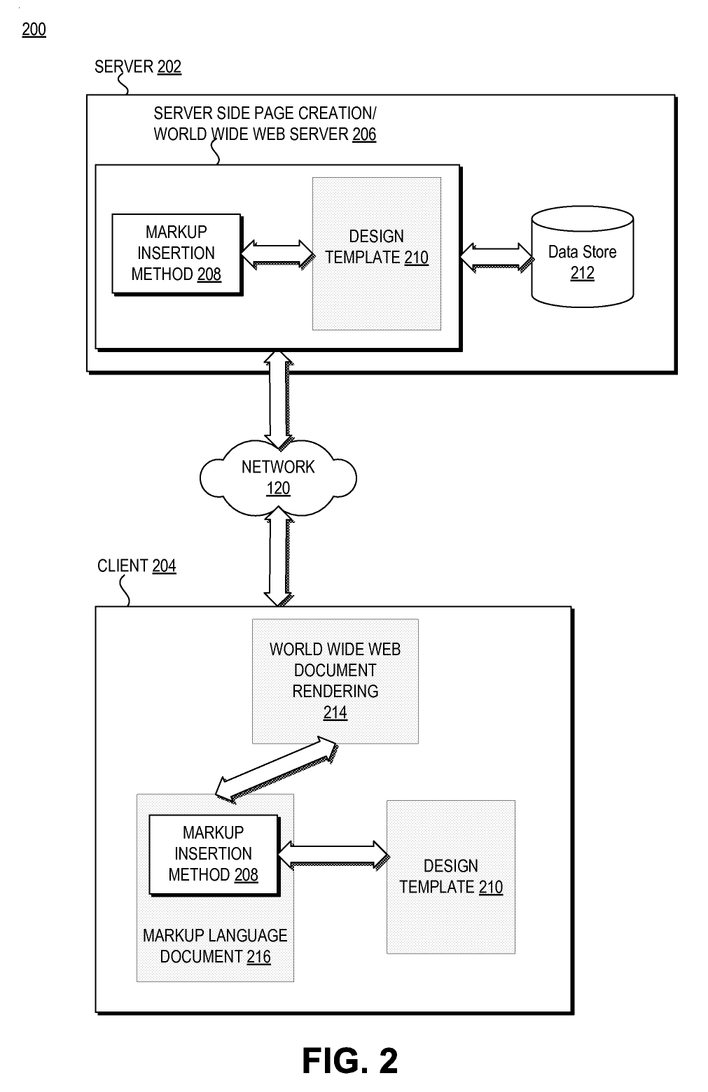

FIG. 2 shows an example embedded markup resource system 200. The embedded markup resource system 200 includes a server 202 and a client 204. The server 202 includes a server side page creation and world wide web server component 206 and a data store 212. The server side page creation and world wide web server component 206 includes a markup insertion method 208 and a design template 210. The server side creation component 202 is communicatively coupled to the data store 206.

The client 204 includes a world wide web document rendering component 214, a markup language document 216, and the design template 210. The markup language document 216 includes the markup insertion method 208. The client 204 is communicatively coupled to the server 202 by a network 120 (from FIG. 1).

The server side page creation and world wide web server component 206 functions to receives requests for markup language documents, dynamically generate markup language documents such as hypertext markup language (HTML) documents, and send the generated markup language documents. For example, the server side page creation and world wide web server component 206 may be comprised of Microsoft® Internet Information Server (IIS) and Active Server Pages (ASP) and/or Active Server Pages for the .Net Runtime (ASP.NET).

The server side page creation and world wide web server component 206 stores the markup insertion method 208 and the design template 210. The server side page creation and world wide web server component 206 may include the markup insertion method 208 in a dynamically generated markup language document if the source markup language document includes a reference to the markup insertion method 208. The design template 210 includes one or more markup language resources indexed by unique identifier. Such markup language resources are reusable portions of markup language code that may be downloaded to the client 204 and located by the markup insertion method 208 during rendering of the markup language document 216. The server side page creation and world wide web server component 206 may send the design template 210 to the client 204.

On the client 204, the world wide web document rendering component 214 parses and renders the markup language document 216 for display on a display device attached to the client 204. For example, the world wide web document rendering component 214 may execute on the computing device 1 00 (from FIG. 1) and may display the rendered version of the markup language document 21 6. In another example, the world wide web document rendering component 214 is a world wide web browser such as Microsoft® Internet Explorer@.

The world wide web document rendering component 214 may produce a document object model (DOM) corresponding to the markup language document 216. The document object model is a hierarchical representation of the markup language elements included in the markup language document 216. The world wide web document rendering component 214 may traverse such a document object model adding, deleting, modifying elements or nodes within the document object model. For example, a document object model fragment may be created and inserted into the document object model.

When the markup language document 216 is rendered by the world wide web document rendering component 214, the world wide web document rendering component 214 may encounter and execute the markup insertion method 208. The markup insertion method 208 may be a function written in any computer programming language, for example, a runtime scripting language such as Javascript, VBScript, or the like.

The markup insertion method 208 may request a markup language resource from the design template 210. Once the markup language resource has been retrieved, the markup insertion method 208 may create a document object model (DOM) node or fragment including markup language code included in the markup language resource. The markup insertion method 208 may then insert the document object model node or fragment into the document object model corresponding to the markup language document 216.

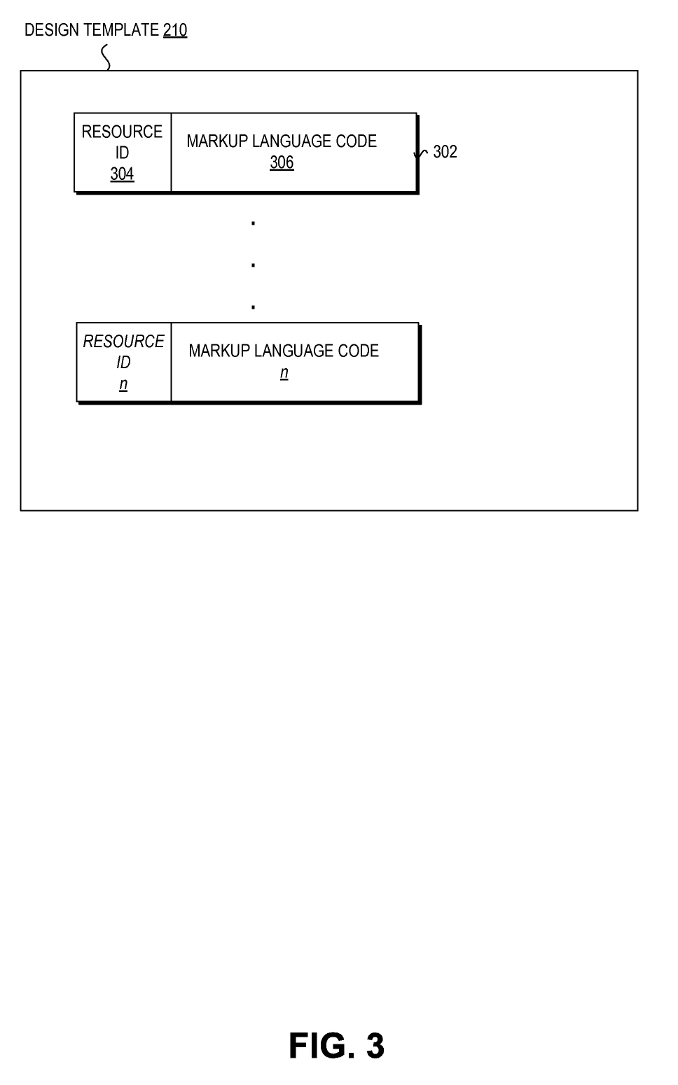

Turning now to FIG. 3, FIG. 3 shows an example design template 210 including a markup language resource 302. The markup language resource 302 includes a resource identifier 304 and a markup language code string 306.

The resource identifier is a valid ID name for a markup element, for example, any token, number, letters, combination of letter and numbers, and the like. The markup language code string 306 includes a string of markup language code. The markup language code may be any markup language such as hypertext markup language (HTML), extensible markup language (XHTML), extensible markup language (XML), and the like.

The markup language code 306 may include markup language code to render a user interface element on a world wide web browser or the like. For example, the markup language code 306 may include HTML to render a table, a button, or the like. The markup language code 306 may further include identifiers and links to data sources such that the user interface controls are “databound” to a data source. The user interface elements may then reflect the data stored in the data source when rendered.

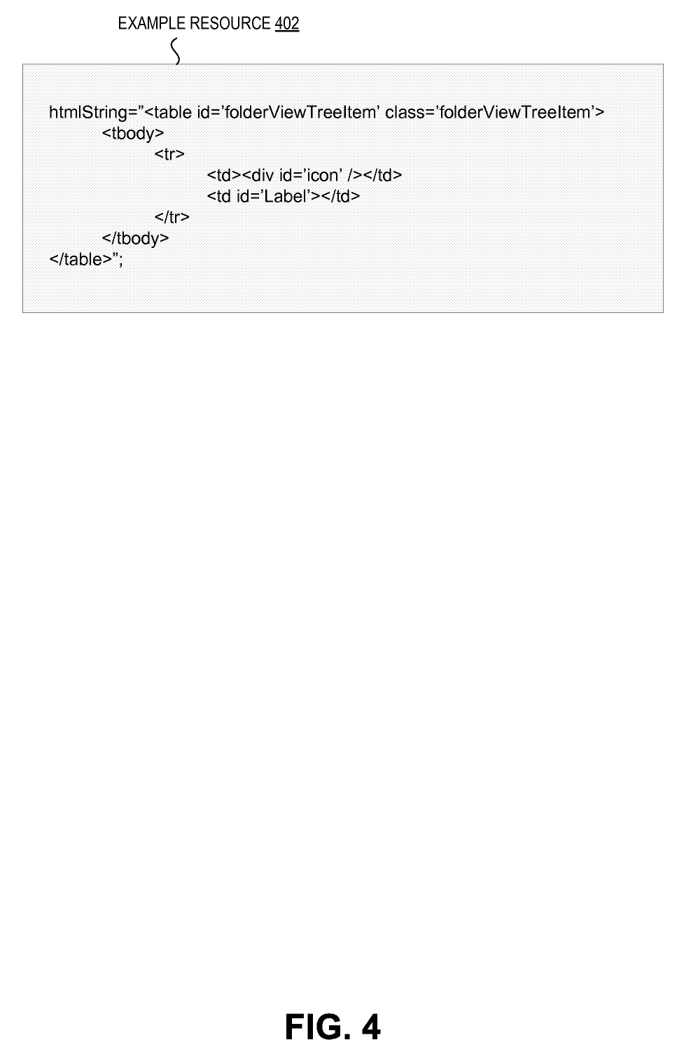

For example, FIG. 4 shows an example implementation of a markup language resource 402. In this example, an HTML <table> is included in the javascript variable “htmlString”. The HTML <table> includes an HTML “id” attribute that uniquely identifies this portion of markup language code. The HTML <table> further includes an HTML “class” attribute that specifies this HTML <table> is a member of the “folderViewTreeltem” class and when rendered will make use of a cascading style sheets (CSS) presentation class.

The HTML <table> includes a number of child elements, for example an HTML table row “<tr>” element, which further includes a number of HTML table cell “<td>” elements. The first HTML table cell “<td>” element includes an HTML division “<div>” element that further includes an HTML “id” attribute. Such an identifier attribute may refer to another markup language fragment located in a design template. Similarly, the second HTML table cell “<td>” element includes an HTML “id” attribute that may refer to another markup language fragment location in a design template.

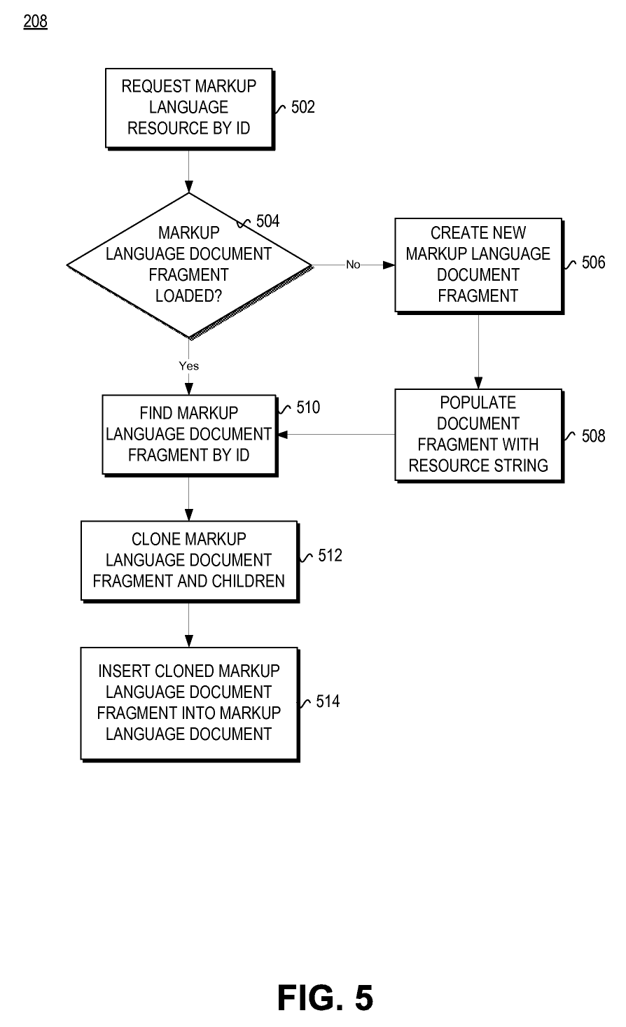

Turning now to FIG. 5, FIG. 5 shows an example markup insertion method 208 (from FIG. 2). Block 502 refers to an operation in which a request to locate a markup language resource using an identifier is received. Such a request may be a function call including the identifier as a parameter. Flow continues to block 504.

Block 504 refers to a determination whether or not the markup language code associated with the markup language resource requested at block 502 is loaded in memory. In response to a negative determination, flow continues on to block 506. In response to a positive determination, flow continues on to block 51 0.

Block 506 refers to an operation in which a new markup language document fragment is created. Flow continues on to block 508, where the markup language code associated with the markup language resource requested at block 502 is inserted into the document fragment created at block 506.

Block 510 refers to an operation to locate the markup language document fragment associated with the identifier received at block 502. Once the markup language document fragment associated with the identifier received at block 502 has been located, flow continues to block 512.

Block 512 refers to an operation in which the markup language document fragment located at block 510 is “cloned” or copied. Block 514 refers to an operation in which the cloned markup language document fragment is inserted into the appropriate location in the original markup language document.

1. One or more device-readable media having device-executable instructions for performing steps comprising:
receiving a request for a markup language resource;
locating the markup language resource;
creating a copy of a portion of markup language code associated with the markup language resource;
returning the copy of the portion of the markup language code associated with the markup language resource; and
inserting the copy of the portion of the markup language code into a markup language document.

2. The one or more device-readable media having device-executable instructions of claim 1 wherein the request includes a unique identifier of the markup language resource.

3. The one or more device-readable media having device-executable instructions of claim 1 wherein locating the markup language resource further comprises:
determining if the markup language code associated with the markup language resource is stored in memory;
creating a document fragment associated with the markup language resource and storing the document fragment in memory in response to a negative determination; and
populating the document fragment with the markup language code.

4. The one or more device-readable media having device-executable instructions of claim 1, wherein the copy of the portion of the markup language code is stored in a document object model fragment.

5. The one or more device-readable media having device-executable instructions of claim 1, wherein the markup language code is hypertext markup language (HTML) code.

6. The one or more device-readable media having device-executable instructions of claim 1, wherein the markup language code is extensible hypertext markup language (XHTML) code.

7. The one or more device-readable media having device-executable instructions of claim 1 wherein the markup language code is extensible markup language (XML).

8. The one or more device-readable media having device-executable instructions of claim 1 wherein the markup language resource comprises a unique identifier and markup language code stored as a string.

9. The one or more device-readable media having device-executable instructions of claim 1 wherein the markup language resource is stored in a source code file.

10. The one or more device-readable media having device-executable instructions of claim 1 wherein the markup language resource is stored in javascript code.

11. The one or more device-readable media having device-executable instructions of claim 1, wherein the markup language resource includes markup language code representing a template for a user interface element.

12. The one or more device-readable media having device-executable instructions of claim 1, wherein the markup language resource includes markup language code that performs data binding.

13. The one or more device-readable media having device-executable instructions of claim 1, wherein the markup language document is parsed and rendered by a world wide web browser executing on a client.

14. A system, comprising:
a markup language document renderer for executing a markup insertion method, the markup insertion method requesting a markup language resource stored in a design template and for creating a markup language document using the received markup language code associated with the markup language resource; and
a design template for storing at least one markup language resource.

15. The system of claim 14, further comprising a data store for storing data to be databound to at least one user interface control associated with the markup language resource.

16. The system of claim 14, wherein the design template is a javascript file.

17. The system of claim 14, wherein the markup insertion method is a function written in a runtime scripting language.

18. A method, comprising
sending a request for a markup language resource;
receiving a clone of a portion of markup language code associated with the markup language resource; and
inserting the copy of the portion of the markup language code into a markup language document.

19. The method of claim 18, wherein the portion of markup language code is a hypertext markup language (HTML) fragment.

20. The method of claim 18, wherein the markup language document is a hypertext markup language (HTML) document object model.
